(19) United States
(12) Patent Application Publication
(10) Pub. No.: US 2015/0347467 A1
(43) Pub. Date: Dec. 3, 2015

(54) DYNAMIC CREATION OF DOMAIN SPECIFIC CORPORA

(71) Applicant: International Business Machines Corporation, Armonk, NY (US)

(72) Inventors: Sara H. Basson, White Plains, NY (US); Kember A.-R. Forcke, Richmond, VA (US); Richard T. Goodwin, Dobbs Ferry, NY (US); Kaan K. Katircioglu, Yorktown Heights, NY (US); Meir M. Laker, Spring Valley, NY (US); Jonathan Lenchner, North Salem, NY (US); Pietro Mazzoleni, New York City, NY (US); Nitinchandra R. Nayak, Ossining, NY (US); John G. Vergo, Yorktown Heights, NY (US); Wlodek W. Zadrozny, Tarrytown, NY (US)

(73) Assignee: International Business Machines Corporation, Armonk, NY (US)

(21) Appl. No.: 14/287,474

(22) Filed: May 27, 2014

(51) Int. Cl. G06F 17/30

(52) U.S. Cl. CPC G06F 17/30289; G06F 17/30525; G06F 17/3043

(57) ABSTRACT

A model of a domain is received, wherein the model has a plurality of elements. A corpus of select documents covering the plurality of elements of the model is also received. A plurality of select topics is generated from the corpus of select documents. Topics of an additional document are compared to the plurality of select topics to calculate a distance between the topics of the additional document and the plurality of select topics. Upon the distance meeting a threshold value, a new corpus is generated to include the additional document. The new document is annotated with the plurality of elements of the model.

### FIELD OF THE INVENTION

The present disclosure generally relates to automated data processing, and more particularly to automated processing of natural language text.

### BACKGROUND

Computer analytics tools can analyze a corpus of information to generate data or make a decision based on contents of the corpus of information. For example, analytics tools are used by IBM Watson™ to search and analyze contents of document corpora to answer natural language questions, based on the content appearing in the corpora. Such a tool may be, for example, a question-answering (QA) tool, such as IBM Watson™. The quality of the answers determined by the tool depends in part on the quality of the underlying corpus or corpora: the more specific a corpus is to a question domain, the more likely the analytics tool is to find a corresponding answer that has a desirable quality.

Generating corpora for use by analytics tools such as those described above is time consuming and requires intensive human intervention, particularly when developing a corpus for a new QA domain. Therefore, it may be desirable to develop an automated means for creation of high quality corpora for new QA domains, which enables the QA tools to achieve higher levels of precision and accuracy.

### BRIEF SUMMARY

Embodiments of the present disclosure provide a method, system, and computer program product for generating a domain-relevant corpus for use in a question answering (QA) application. A corpus of select documents corresponding to a plurality of elements of a model of a domain is received, and a plurality of select topics is generated based on the corpus of select documents. Topics of an additional document are compared to the plurality of select topics to obtain a distance measure between the topics of the additional document and the plurality of select topics. Upon the distance measure matching a set of selection criteria, the additional document is added to a new corpus.

### BRIEF DESCRIPTION OF THE SEVERAL VIEWS OF THE DRAWINGS

FIG. 1 is a schematic block diagram depicting an exemplary computer system for generating a domain-specific corpus, according to aspects of the present disclosure;

FIG. 2 is a flow chart depicting steps of a program of the computer system in FIG. 1, according to aspects of the present disclosure;

FIG. 3 is a schematic block diagram of a computer system, in accordance with an embodiment of the present disclosure;

FIG. 4 is a block diagram of an illustrative cloud computing environment, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

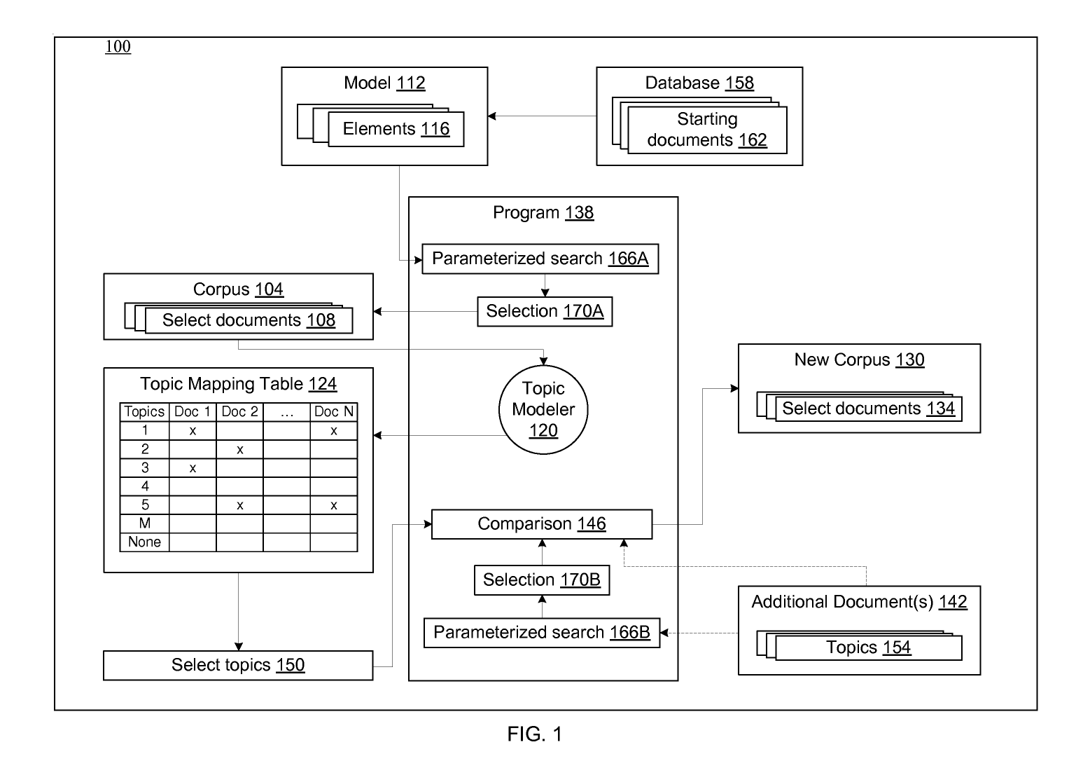

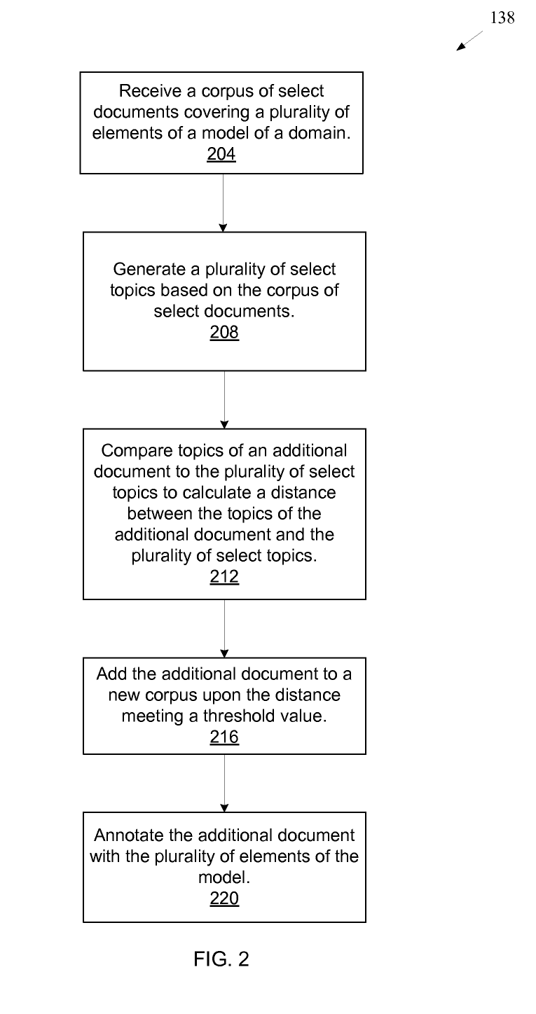

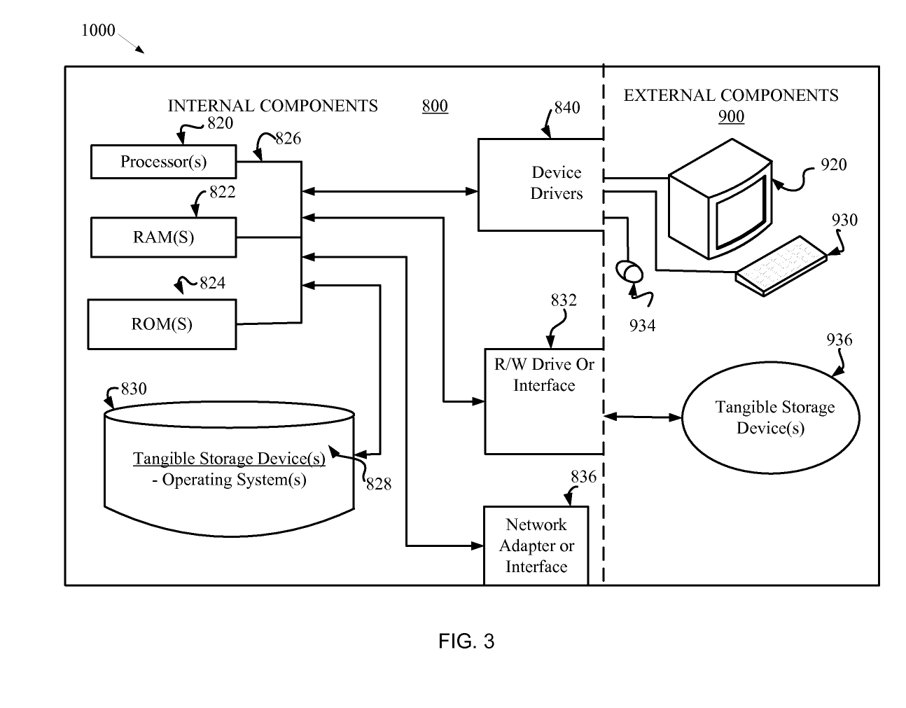

FIG. 1 is a schematic block diagram depicting an exemplary corpus generation system 100 that generates a domain-specific corpus for use in a question-answering (QA) application, according to aspects of the present disclosure. The corpus generation system 100 may be deployed on a single computing device or a collection of computing devices as described in connection with FIG. 3, below. The corpus generation system 100 may include a program 138 embodied on, for example, a tangible storage device of a computing system, for execution of steps of a method for generating a domain-specific corpus. Steps of the method of the program 138 are discussed in greater detail in connection with FIG. 2, below.

QA refers to the computer science discipline within the fields of information retrieval and natural language processing (NLP) known as Question Answering. QA relates to computer systems that can automatically answer questions posed in a natural language format. A QA application may be defined as a computer system or software tool that receives a question in a natural language format, and queries data repositories and applies elements of language processing, information retrieval, and machine learning to results obtained from the data repositories to generate a corresponding answer. An example of a QA tool is IBM's Watson™ technology, described in great detail in IBM Journal of Research and Development, Volume 56, Number 3/4, May/July 2012, the contents of which are hereby incorporated by reference in its entirety.

As described below, embodiments of the present disclosure may perform a search of a set of starting documents, stored in a database of starting documents, based on a computerized model and its elements, to select a corpus of selected documents. The selected documents may represent a desired level of quality in relation to the computerized model and its elements. The selected documents may be used to assess the quality of additional documents on a large scale and automated manner. Accordingly, the selected documents may be used as seed documents, or as points of reference, to gauge the quality of additional documents automatically and systematically, so that generation of additional corpora or expanding existing corpora can be done more efficiently and effectively than is possible by current technologies.

With continued reference to FIG. 1, a corpus 104 may be generated using select documents 108, selected from a set of starting documents 162 contained in a database 158. The starting documents 162 may be any digital document containing searchable text. The database 158 may be, without limitation, a database available over the Internet or any other public or private network or server.

Generation of the corpus 104 using the select documents 108 from the set of starting documents 162 may be facilitated through the use of a computer program 138 of the corpus generation system 100. Each starting document 162 may be a digital document including text and/or metadata, for example, a digital text file embodied on a tangible storage device of the corpus generation system 100 or a tangible storage device of another system in communication with the corpus generation system 100. The computer program 138 may be embodied on a tangible storage device of the corpus generation system 100 and or a computing device (as described in connection with FIG. 3, below). A parameterized search component 166A of the program 138 may perform a search of the starting documents 162 to generate one or more candidate documents (not shown).

The search performed by the parameterized search component 166A may be based on elements 116 of a model 112, and further based on one or more defined parameters (not shown). On the one hand, the model 112, on which the parameterized search is partially based, may be any model relating to a domain of knowledge (e.g., a business plan model relating to a business domain). Elements 116 of the model 112 may be, for example, words or sections of the model 112. On the other hand, the parameters on which the parameterized search is partially based may each comprise a word or phrase relating to a narrowing of the domain of the model 112 (e.g., a sub-domain), which serves to narrow the scope of the starting documents 162 available on the database 158. For example, where the domain of the model 112 is {business}, the sub-domain may be {restaurant}. The parameters may therefore be defined based on words or phrases that relate to a restaurant in particular, and may be combined with elements 116 of the business model 112 to form search terms that relate to the restaurant business.

Where a parameterized search has been performed by the parameterized search component 166A, a selection component 170A of the program 138 may select one or more of the candidate documents (not shown) to be added to the corpus 104 as a select document 108. The selection by the selection component 170A may be made based on one or more predefined selection criteria, and/or based on user input. The predefined selection criteria may include, for example: select any document that contains at least (n) instances of a search phrase (the search phrase including a parameter and an element 116 of the model 112); reject any document having a modified-date attribute older than 10 years; select any document that has an associated rating, wherein the rating is higher than 3; select any document a sufficient number of whose topics correspond to elements 116 of the model 112.

According to an illustrative example, the domain of the model 112 may be defined as {business}. The corresponding model 112 may be, for example, a {business plan}. The business plan may have a plurality of elements 116 including, for example: {strategy, marketing, operations, income statement, cash flow}. A defined parameter used by the parameterized search component 166A may be, for example, {restaurant}. The parameterized search 166A component may search the starting documents 162 on the database 158 using one or more of the following phrases: {restaurant strategy, restaurant marketing, restaurant operations, restaurant income statement, restaurant cash flow}. The parameterized search component 166A returns a set of candidate documents (not shown), and the selection 170A selects one or more of the candidate documents and adds them to the corpus 104 as select documents 108. The selection may also involve user input, and may be entirely manual. In either case, in this example, the corpus 104 represents a repository of information regarding the restaurant business that meet a criteria for quality.

Although the parameterized search may be performed by the parameterized search component 166A of the program 138 on the corpus generation system 100, it may also be performed by another program on another computing device or system. Additionally, it is not necessary that embodiments of the present disclosure perform the parameterized search. Rather, it is sufficient that the program 138 can access and/or receive the corpus 104 to perform the claimed functions of the present disclosure.

With continued reference to FIG. 1, the program 138 may generate the corpus 104 or may obtain it from another source. As described above, the corpus 104 may comprise a collection of select documents 108 having a desired level of quality in relation to the model 112 of a domain, and in relation to the model's 112 constituent elements 116. The quality of a document in relation to the model 112 may be based on one or more selection criteria.

With continued reference to FIG. 1, the select documents 108 may be analyzed by a topic modeling component 120 of the program 138, which receives the select documents 108 of the corpus 104 and generates a mapping table 124 that comprises a set of topics. The mapping table 124 is generated to indicate, for any generated topic, which of the select documents contain that topic. As depicted in FIG. 1, in the mapping table 124, for each given topic in {1-M}, and for each given select document {1-N}, an “x” mark in a corresponding cell indicates that the given topic appears in the given select document. The topic modeler 120 may select n topics from the mapping table 124 to generate a corresponding set of select topics 150.

A given select document 108 may yield more than one topic. The number of topics selected from the topic mapping table 124 to generate the select topics 150 may be different depending on the particular embodiment of the present disclosure, and may be configurable by a user. The program 138 may modify the selection by removing topics from the set of select topics 150 that would otherwise be added to the set of select topics 150, which may be desirable where, for example, one or more of the select topics are deemed too specific.

The selection of topics may further be based on predefined selection criteria. The selection criteria may include, for example: selection of the n most frequently appearing topics; exclusion of topics deemed too broad, too specific, or too similar to another topic; etc.

The mapping table 124 is one illustrative example of a selection process, and does not limit the spirit or scope of the present disclosure in selecting the select topics 150.

According to an exemplary embodiment of the present disclosure, the topic modeler 120 described above may be a Latent Dirichlet Allocation (LDA) based topic modeler. According to the publication “Latent Dirichlet Allocation” by David Blei et al., published in the Journal of Machine Learning Research 3 (January 2003) 993-1022, incorporated herein by reference in its entirety, LDA is a generative probabilistic model for collections of discrete data such as text corpora. LDA is a three-level hierarchical Bayesian model, in which each item of a collection is modeled as a finite mixture over an underlying set of topics. Each topic is, in turn, modeled as an infinite mixture over an underlying set of topic probabilities. In the context of text modeling, the topic probabilities provide an explicit representation of a text document. LDA includes efficient approximate inference techniques based on variational methods and an expectation maximization algorithm for empirical Bayes parameter estimation.

According to an illustrative example, where the corpus 104 and its constituent select documents 108 are based on a business model, the corresponding select topics 150 generated by the topic modeler 120 of the program 138 may include: {menu, location, pricing, promotions, expenses, profits}. The program 138 may modify this set of select topics 150 to exclude, for example, the {promotions} topic, because it may not meet a predefined or specified criteria. These select topics 150 may be used by embodiments of the present disclosure to evaluate the quality of other documents (i.e., one or more additional documents 142) compared to the select documents 108.

To judge the quality of other documents, the program 138 may process each additional document 142 having one or more topics 154 using a comparison component 146. The additional documents 142 may be similar in format to the format of the select documents 108, and may be obtained from the same or similar type of source, as described above. The topics 154 of the additional documents 142 may be determined by the topic modeler 120 of the program 138, or may be determined by a different program on a system other than the corpus generation system 100, whereby the topics 154 are pre-determined at the point of access by the program 138 on the corpus generation system 100.

The comparison component 146 of the program 138 may perform a comparison for each additional document 142 received by the corpus generation system 100, by comparing its topics 154 to the select topics 150, to determine whether the additional document 142 meets a desired level of quality. The quality of the additional document 142, as assessed by the comparison component 146, may include determining a “distance” measure indicating similarity, such as a Euclidian distance or a cosine similarity measure, between the select topics 150 and the topics of the additional document 142. In a related embodiment, a threshold T may be specified in lieu of a distance measure indicating similarity, whereby a given additional document 142 is considered to meet a desired level of similarity where at least T % of the topics 154 found in the additional document 142 match the select topics 150.

For each additional document 142 whose topics 154 meet the desired level of quality as assessed by the similarity measure, the additional document 142 is added to a new corpus 130 as a new select document 134.

Exemplary and non-limiting similarity measures that may be used are described in Analyzing Document Similarity Measures. Dissertation [online]. Edward Grefensette, University of Oxford Computing Laboratory, Aug. 28, 2009 [retrieved on Dec. 18, 2013]. Retrieved from the Internet: <URL: www.academia.edu/188660/Analysing_Document_Similarity_Measures>, incorporated herein by reference in its entirety.

With continued reference to FIG. 1, in a related embodiment, prior to adding any additional documents 142 to the new corpus 130 as a new select document 134, one or more of the additional documents 142 may be searched by the program 138 using a parameterized search component 166B. This may be done in the same manner as described above with respect to the parameterized search 166A of the starting documents 162 in the database 158. Performing a parameterized search by the parameterized search component 166B for the additional documents 142 may be desirable where it is desirable that the corresponding new corpus 130 contain yet more specific documents. In the example above where the model 112 is a business and the select documents of the corresponding corpus 104 relate to the restaurant business, performing a parameterized search 166B may enable embodiments of the present disclosure to generate the new corpus 130 such that it contains documents deemed particularly useful to a sub-domain of the restaurant business domain. Parameters (not shown) used in the parameterized search, in this example, may include: {gourmet, vegan, take-out, fast-food}. These parameters may be used to generate corresponding search phrases. It is not necessary for the additional documents 142 to undergo the parameterized search 166B or the selection 170B prior to being processed by the comparison component 146. Where the parameterized search 166B is used, it may be identical, or similar to, or different from, the parameterized search 166A component of the program 138.

Where the parameterized search component 166B performs a parameterized search of the additional documents 142, a second set of candidate documents (not shown) may be generated. A second selection component 170B of the program 138 may select one or more of such candidate documents for comparison by the comparison component 146. The comparison component 146 may perform the same functions as described above with respect to the additional documents 142 that are not subjected to a parameterized search or subsequent selection, to generate or amend the new corpus 130 to include the additional documents 142 in the new corpus 130 as new select documents 134.

Once generated, the new corpus 130 may be amended continually to include each additional document 142 that meets a desired quality measure in relation to the select topics 150, as determined by the comparison component 146 of the program 138. The additional documents 142 added to the new corpus 130, referred to as new select documents 134, may be annotated to include the elements 116 of the model 112.

With continued reference to FIG. 1, contents of the new corpus 130 may be different depending on embodiments of the present disclosure. In one embodiment, the new select documents 134 of the new corpus 130 may be focused and may include a selection of the additional documents 142 that satisfy the desired quality requirement of the comparison 146 component, without also including the select documents 108 of the corpus 104. For example, where the corpus 108 is based on a restaurant business, and the additional documents 142 are selected by the selection 170B component based on their relevance to gourmet restaurants, the new corpus 142 may include the additional documents 142 that are considered high quality documents with respect to gourmet restaurants, but not the select documents 108 of the corpus 104 that relate to restaurant businesses generally. Accordingly, this new corpus 130 may be more focused, and may be used by a QA tool to search for information about restaurant businesses more quickly and efficiently, because it potentially reduces the number of documents that the QA tool analyzes to arrive at an answer. This may be preferred where the QA tool is used to answer questions about restaurant businesses, and there is no need to search the relatively general select documents 108.

In a related embodiment, the new select documents 134 of the new corpus 130 may include at least the additional documents 142 that satisfy requirements of the comparison 146 component, and may also include the select documents 108 in the corpus 130. Generating such a new corpus 130 may be desirable where, for example, select documents 108 of the corpus 104 and the additional documents 142 that meet the quality requirement of the comparison 146 component of the program 138 are deemed valuable for use by a QA tool, particularly where there is no need or desire to limit the scope of the documents available to the QA tool.

In a related embodiment, where one or more additional documents 142 are added to the new corpus 130, the select topics 150 may be updated to include the topics 154 of each additional document 142 that meets the desired quality of the comparison 146 component. Effectively, the select topics 150 are expanded, and may be used in assessing the quality of any additional document 142 that is subsequently evaluated by the comparison component 146. The expanded select topics 150 may facilitate a more focused comparison by the comparison component 146, because an additional document 142 will need to not only have a sufficient correspondence to the original set of select topics 150, but also the expanded select topics 150. Accordingly, the comparison becomes more focused and more restrictive, yielding a more focused new corpus 130.

In a related embodiment (not shown), where one or more additional documents 142 are added to the new corpus 130, the select topics 150 are not updated to include the topics 154 of each additional document 142 that meets the desired quality of the comparison 146 component. This may be desirable where, for example, the select topics 150 are used to select a variety of additional documents 142, rather than a focused and specific group of additional documents 142. In the example where the select topics 150 relate to restaurant businesses in general, and the comparison component 146 adds additional documents 142 to the new corpus 130 that relate to gourmet restaurants, vegan restaurants, or other types of restaurants, it may be desirable not to amend the select topics 150 with topics 154 of the additional documents 142 that relate to gourmet restaurants in particular. This may be desirable because adding the topics 154 that relate to gourmet restaurants to the select topics 150 may render subsequent comparisons by the comparison component 146 unduly restrictive. For example, additional documents 142 that relate to vegan restaurants may be rejected by the comparison component 146 because the distance measure between topics of such additional documents 142 and the amended select topics 150 may exceed the specified threshold value of the comparison component 146.

With continued reference to FIG. 1, in a related embodiment, the corpus generation system 100 may include a search component (not shown) that may search the select documents 108 of the corpus 104, and/or the new select documents 134 of the new corpus 130, based on one or more search parameters. These search parameters may be derived from a domain-relevant ontology source. An example of an ontology source may be a document containing metadata that relates its textual elements to one another based on a system of classes and properties that allow analysis of those textual elements. Ontology sources and manners of their use are described in Why Did That Happen? OWL and Inference: Practical Examples. Tutorial [online]. Sean Bechhofer [retrieved Dec. 18, 2013]. Retrieved from the Internet: <URL: http://owl.man.ac.uk/tutorial/owl-tutorial-why.ppt>, incorporated herein by reference in its entirety. Ontology sources and manners of their use are additionally described in Reasoning With Expressive Description Logics: Theory and Practice [online]. Ian Horrocks and Sean Bechhofer [retrieved Dec. 18, 2013]. Retrieved from the Internet: <http://owl.man.ac.uk/tutorial/pt1-swintro.ppt>, incorporated herein by reference in its entirety.

The search parameters derived from ontology sources may be combined with one or more of the select topics 150, and/or one or more of the topics of the select documents 134. The search parameters may also be based on a natural language question as processed by a QA tool. For example, the QA tool may extract key terms from the natural language question and use them as parameters to perform a search, whereby the search retrieves those select documents 108 and/or select documents 134 that correspond to the parameters. Based on the contents of the retrieved select documents, the QA tool may perform further analysis functions to arrive at an answer to the natural language question.

FIG. 2 is a flow chart depicting steps of the program 138 of the corpus generation system 100 depicted in FIG. 1, according to an aspect of the present disclosure. The program 138 may receive, in step 204, a corpus of select documents covering a plurality of elements of a model of a domain. As depicted in FIG. 1, these may be, for example, the corpus 104 of the select documents 108 which correspond to the elements 116 of the model 112.

In a related embodiment, the corpus 104 may be generated by the program 138 itself, by performing a parameterized search of a set of starting documents in a database. The starting documents may be, for example, the starting documents 162 in the database 158, as depicted in FIG. 1. The parameterized search may be performed by a parameterized search component 166 of the program 138 to generate a set of candidate documents. A selection component 170A may select one or more of the candidate documents according to a predefined or specified criteria, and add the selected candidate documents to the corpus 104 as select documents 108.

In step 208, the program 138 may generate a plurality of select topics based on the corpus of select documents. The select topics may be, for example, the select topics 150 shown in FIG. 1. Generation of the select topics in step 208 may be done by using the topic modeler 120 of the program 138, which may be an LDA topic modeler. In step 208, the topic modeler 120 may generate a topic mapping table 124, and select the {n} most frequently appearing topics determined by the topic modeler 120 based on the select documents 108 of the corpus 104.

In step 212, the program 138 may compare topics of an additional document to the plurality of select topics to calculate a distance between the topics of the additional document and the plurality of select topics. The additional document may be, for example, the additional document 142 having the topics 154. The program 138 may compare, via the comparing component 146, how closely the topics 154 cover, or correspond to, the select topics 150.

In a related embodiment (not shown), prior to a comparison in step 212, the additional document(s) may be selected by a selection component 170B of the program 138 from amongst a collection of additional documents in a database, where the selected additional document(s) is among a set of candidate documents generated by the parameterized search by the parameterized search component 166 of the program 138.

In step 216, upon a predetermined or specified threshold number or percentage of topics 154 matching the select topics 150, the corresponding additional document 142 may be added to a new corpus. The new corpus may be, for example, the new corpus 130.

In step 220, a document added to the new corpus 130 may be annotated to include the elements 116 of the model 112. The annotated document may be, for example, the annotated document 134.

Referring now to FIG. 3, a computing device 1000 may include respective sets of internal components 800 and external components 900. The corpus generation system 100 shown in FIG. 1 may be implemented using the computing device 1000. Each of the sets of internal components 800 of the computing device 1000 includes one or more processors 820; one or more computer-readable RAMs 822; one or more computer-readable ROMs 824 on one or more buses 826; one or more operating systems 828; one or more software applications (e.g., device driver modules) executing the program 138; and one or more computer-readable tangible storage devices 830. The one or more operating systems 828 and device driver modules are stored on one or more of the respective computer-readable tangible storage devices 830 for execution by one or more of the respective processors 820 via one or more of the respective RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 also includes a R/W drive or interface 832 to read from and write to one or more computer-readable tangible storage devices 936 such as a thin provisioning storage device, CD-ROM, DVD, SSD, memory stick, magnetic tape, magnetic disk, optical disk or semiconductor storage device. The R/W drive or interface 832 may be used to load the device driver 840 firmware, software, or microcode to tangible storage device 936 to facilitate communication with components of computing device 1000.

Each set of internal components 800 may also include network adapters (or switch port cards) or interfaces 836 such as a TCP/IP adapter cards, wireless WI-FI interface cards, or 3G or 4G wireless interface cards or other wired or wireless communication links. The operating system 828 that is associated with computing device 1000, can be downloaded to computing device 1000 from an external computer (e.g., server) via a network (for example, the Internet, a local area network or wide area network) and respective network adapters or interfaces 836. From the network adapters (or switch port adapters) or interfaces 836 and operating system 828 associated with computing device 1000 are loaded into the respective hard drive 830 and network adapter 836. The network may comprise copper wires, optical fibers, wireless transmission, routers, firewalls, switches, gateway computers and/or edge servers.

Each of the sets of external components 900 can include a computer display monitor 920, a keyboard 930, and a computer mouse 934. External components 900 can also include touch screens, virtual keyboards, touch pads, pointing devices, and other human interface devices. Each of the sets of internal components 800 also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

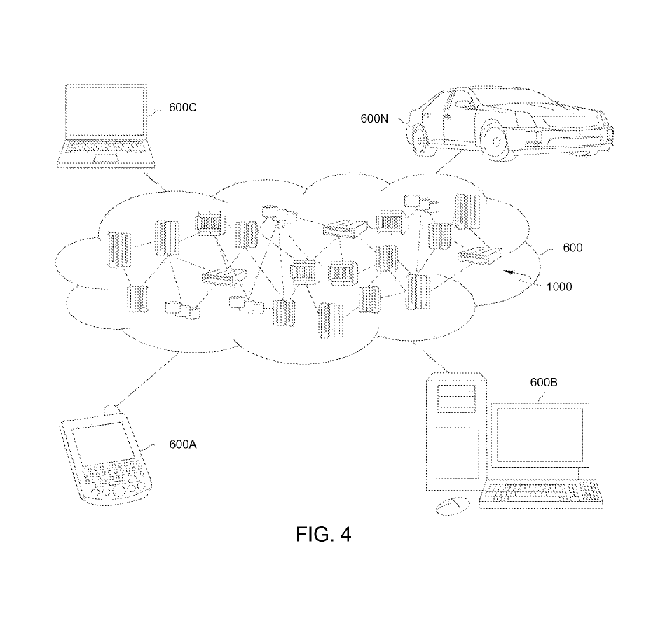

Referring now to FIG. 4, an illustrative cloud computing environment 600 is depicted. As shown, the cloud computing environment 600 comprises one or more cloud computing nodes, each of which may be a system 1000 with which local computing devices used by cloud consumers, such as, for example, a personal digital assistant (PDA) or a cellular telephone 600A, a desktop computer 600B, a laptop computer 600C, and/or an automobile computer system 600N, may communicate. The nodes 1000 may communicate with one another. They may be grouped (not shown) physically or virtually, in one or more networks, such as Private, Community, Public, or Hybrid clouds as described hereinabove, or a combination thereof. This allows the cloud computing environment 600 to offer infrastructure, platforms and/or software as services for which a cloud consumer does not need to maintain resources on a local computing device. It is understood that the types of computing devices 600A-N shown in FIG. 4 are intended to be illustrative only and that the computing nodes 1000 and the cloud computing environment 600 can communicate with any type of computerized device over any type of network and/or network addressable connection (e.g., using a web browser).

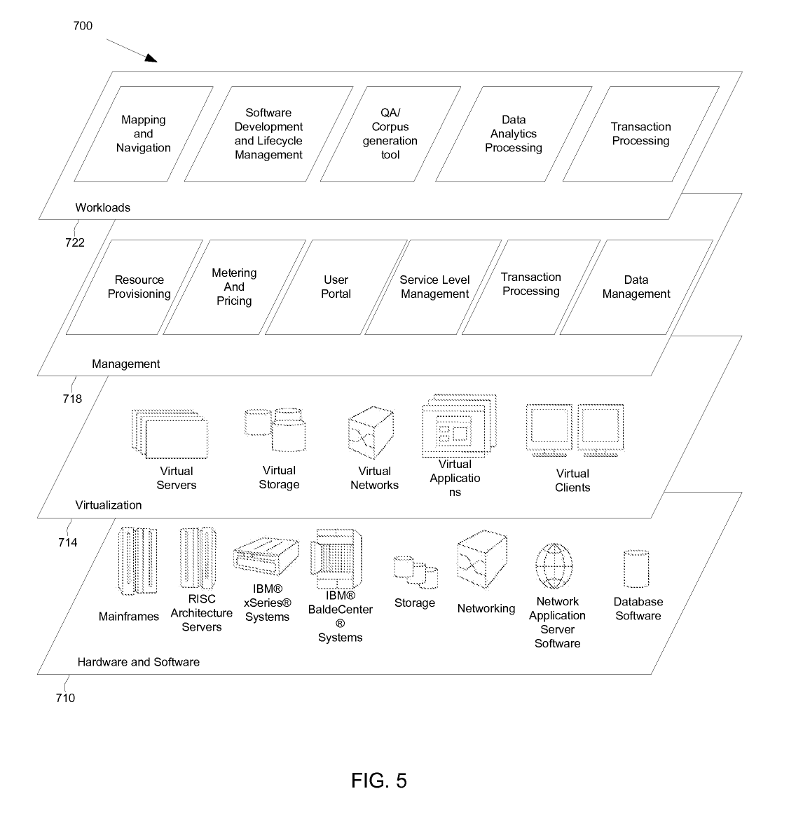

Referring now to FIG. 5, a set of functional abstraction layers 700 provided by the cloud computing environment 600 (FIG. 4) is shown. It should be understood in advance that the components, layers, and functions shown in FIG. 5 are intended to be illustrative only and embodiments of the invention are not limited thereto. As depicted, the following layers and corresponding functions are provided.

The hardware and software layer 710 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

The virtualization layer 714 provides an abstraction layer from which the following examples of virtual entities may be provided: virtual servers; virtual storage; virtual networks, including virtual private networks; virtual applications and operating systems; and virtual clients.

In one example, the management layer 718 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

The workloads layer 722 provides examples of functionality for which the cloud computing environment may be utilized. Examples of workloads and functions which may be provided from this layer include: mapping and navigation; software development and lifecycle management; virtual classroom education delivery; data analytics processing; transaction processing; and a QA tool, and/or a tool for generating domain-relevant corpora, such as that provided for by embodiments of the present disclosure described in FIGS. 1-4.

While the present invention is particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While steps of the disclosed method and components of the disclosed systems and environments have been sequentially or serially identified using numbers and letters, such numbering or lettering is not an indication that such steps must be performed in the order recited, and is merely provided to facilitate clear referencing of the method's steps. Furthermore, steps of the method may be performed in parallel to perform their described functionality.

What is claimed is:

1. A computer implemented method for generating a domain-relevant corpus for use in a question answering (QA) application, the method comprising:
receiving a corpus of select documents corresponding to a plurality of elements of a model of a domain;
generating a plurality of select topics based on the corpus of select documents;
comparing topics of an additional document to the plurality of select topics to obtain a distance measure between the topics of the additional document and the plurality of select topics; and
upon the distance measure matching a set of selection criteria, adding the additional document to a new corpus.

2. The method of claim 1, further comprising:
annotating the additional document with the plurality of elements of the model.

3. The method of claim 1, wherein the new corpus further comprises the corpus of select documents.

4. The method of claim 1, further comprising:
updating the plurality of select topics to include the topics of the additional document.

5. The method of claim 1, wherein the received corpus of select documents is generated based on a parameterized search of a set of starting documents.

6. The method of claim 5, further comprising:
assessing a quality measure of each document in the set of starting documents to generate the corpus of select documents.

7. The method of claim 1, further comprising:
searching any one or both of the corpus of select documents and the new corpus using a search phrase, wherein the search phrase is based on any one or more of:
a phrase from a domain-relevant ontology source;
the select topics; and
the topics of the additional document.

8. A computer system for generating a domain-relevant corpus for use in a question answering (QA) application, comprising:
a computer having a processor and a computer-readable storage device;
a program embodied on the storage device for execution by the processor, the program having a plurality of program modules, the program modules including:
a receiving module configured to receive a corpus of select documents corresponding to a plurality of elements of a model of a domain;
a generating module configured to generate a plurality of select topics based on the corpus of select documents;
a comparing module configured to compare topics of an additional document to the plurality of select topics to obtain a distance measure between the topics of the additional document and the plurality of select topics; and
an adding module configured to add the additional document to a new corpus upon the distance measure matching a set of selection criteria.

9. The system of claim 8, further comprising:
an annotating module configured to annotate the additional document with the plurality of elements of the model.

10. The system of claim 8, wherein the new corpus further comprises the corpus of select documents.

11. The system of claim 8, further comprising:
an updating module configured to update the plurality of select topics to include the topics of the additional document.

12. The system of claim 8, wherein the received corpus of select documents is generated based on a parameterized search of a set of starting documents.

13. The system of claim 12, further comprising:
an assessing module configured to assess a quality measure of each document in the set of starting documents to generate the corpus of select documents.

14. A computer program product for generating a domain-relevant corpus for use in a question answering (QA) application, comprising a computer-readable storage medium having program code embodied therewith, the program code executable by a processor of a computer to perform a method comprising:
receiving, by the processor, a corpus of select documents corresponding to a plurality of elements of a model of a domain;
generating, by the processor, a plurality of select topics based on the corpus of select documents;
comparing, by the processor, topics of an additional document to the plurality of select topics to obtain a distance measure between the topics of the additional document and the plurality of select topics; and
upon the distance measure matching a set of selection criteria, adding, by the processor, the additional document to a new corpus.

15. The computer program product of claim 14, wherein the method further comprises:
annotating, by the processor, the additional document with the plurality of elements of the model.

16. The computer program product of claim 14, wherein the new corpus further comprises the corpus of select documents.

17. The computer program product of claim 14, wherein the method further comprises:
updating, by the processor, the plurality of select topics to include the topics of the additional document.

18. The computer program product of claim 14, wherein the received corpus of select documents is generated based on a parameterized search of a set of starting documents.

19. The computer program product of claim 18, further comprising:
assessing a quality measure of each document in the set of starting documents to generate the corpus of select documents.

20. The computer program product of claim 14, wherein the method further comprises:
searching, by the processor, any one or both of the corpus of select documents and the new corpus using a search phrase, wherein the search phrase is based on any one or more of:
a phrase from a domain-relevant ontology source;
the select topics; and
the topics of the additional document.
